(19) United States
(12) Patent Application Publication
(10) Pub. No.: US 2007/0040291 A1
(43) Pub. Date: Feb. 22, 2007

(54) Optical element forming mold and manufacturing method thereof

(75) Inventor: Atsushi Naito, Aichi-ken (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 11/504,574

(22) Filed: Aug. 15, 2006

(30) Foreign Application Priority Data
Aug. 18, 2005 (JP) 2005-237776

(51) Int. Cl. B29D 11/00; B29C 33/00

(52) U.S. Cl. 264/2.5; 249/114.1

(57) ABSTRACT

An optical element forming mold has a mold face for molding an optical element, and comprises: a matrix with a mold base level; a heat insulating layer provided over the mold base level of the matrix; an intermediate layer provided on the heat insulating layer; and a surface processed layer covering the intermediate layer. Out of the face of the surface processed layer, an upper portion of the mold base level over the matrix is a mold face. It is preferable that the heat insulating layer is a ceramic layer, the surface processed layer is a metallic material layer, and thickness of the intermediate layer does not exceed 200 μm. In this way there is provided an optical element forming mold equipped with a surface processed layer excellent in adhesion and capable of realizing high duplication accuracy.

### CROSS-REFERENCE TO RELATED APPLICATIONS

This application is based upon and claims the benefit of priority from the prior Japanese Patent Application No. 2005-237776 filed on Aug. 18, 2005, the entire contents of which are incorporated herein by reference.

### BACKGROUND OF THE INVENTION

1. Field of the Invention

The present invention relates to an optical element forming mold for manufacturing optical elements such as optical lens, diffraction grating and the like by injection molding of resin. More particularly, it relates to an optical element forming mold and manufacturing method thereof for forming optical elements to which accuracy of the order of micro-meters or finer is required.

2. Description of the Related Art

There have conventionally been used molds made of metallic material such as steel or the like for forming optical elements by injection molding of synthetic resin. Along advancement of finer and higher precise design of optical products these days, accuracy of the order of micro-meters or finer has been required to optical elements and the like. However, it was difficult for conventional molds to realize such high form-transfer accuracy. Japanese Unexamined Patent Publication No. 2002-96335 discloses conventional technique to form an optical element with high accuracy. The Publication discloses an optical element forming mold in which a heat insulating layer and a surface processed layer formed on a surface of a core made of stainless steel.

Relating to the optical element forming mold directed the above-mentioned Publication, a heat insulating layer is formed on a mold matrix by spraying ceramic material on the surface of the core. A surface processed layer is formed on the heat insulating layer by electroless plating of non-ferrous metallic material. Thereby, the Publication explains, the surface processed layer can be processed in a mold form with high accuracy and a molded item with a significantly little dimension error can be obtained.

However, heating and cooling operations are repeated in the course of forming an optical element with the conventional optical element forming mold. As a result, separation between layers can possibly be caused. Especially, separation is likely to occur between a heat insulating layer made of ceramic material and a surface processed layer made of non-ferrous metallic material due to their thermal expansivity difference. Even though it is partial separation, it can possibly cause subtle deformation and deviation of the surface processed layer. Therefore, such layer separation can possibly degrade form accuracy of molded items.

### SUMMARY OF THE INVENTION

The present invention has been attempted to solve the above-noted problems involved in the conventional optical element forming mold. Thus, an object of the invention is to provide an optical element forming mold equipped with a surface processed layer with excellent adhesion and capable of realizing high form-transfer accuracy, and manufacturing method of the optical element forming mold.

To achieve the above object of the present invention, there is provided an optical element forming mold comprising: a matrix; a heat insulating layer provided over the matrix formed by spraying; an intermediate layer provided on the heat insulating layer; and a surface layer which covers the intermediate layer and includes a mold face for molding an optical element.

According to the present invention, there is also provided a manufacturing method of an optical element forming mold comprising the steps of: forming a heat insulating layer over a matrix by spraying; forming an intermediate layer on the heat insulating layer; forming a surface layer on the intermediate layer; and forming a mold face for molding an optical element on a surface of the surface layer.

With reference to the inventive optical element forming mold, an optical element is molded on a mold face which is, out of a surface of the surface processed layer, an upper portion of mold base level over the matrix. The surface layer covers the intermediate layer, the intermediate layer is provided on the heat insulating layer, and the insulating layer is provided over the mold base level on the matrix by spraying. Therefore, the surface layer is strongly adhered to the heat insulating layer by the intermediate layer. That is, even though heating and cooling is repeated, distortion of the surface layer and the heat insulating layer is eased by the intermediate layer. Therefore, the surface layer has excellent adhesion. Out of the surface of the surface layer, the upper part of the mold base level over the matrix is the mold face. Therefore, high form-transfer accuracy can be realized.

### BRIEF DESCRIPTION OF THE DRAWINGS

These and other objects and advantages of this invention will become more fully apparent from the following detailed description taken with the accompanying drawings in which:

FIG. 1 is a cross sectional view showing an optical element forming mold directed to a present embodiment;

FIG. 2 is a diagram showing details of respective layers;

FIG. 3 is a diagram showing surface roughness of respective layers;

FIG. 4 is a cross sectional view showing an example of a surface processed layer;

FIG. 5 is a cross sectional view of an example of an optical element molded from an optical element forming mold;

FIG. 6 is a cross sectional view of another example of a surface processed layer; and

FIG. 7 is a cross sectional view of another example of an optical element forming mold.

### DETAILED DESCRIPTION OF THE PREFERRED EMBODIMENT

Preferred embodiments of the present invention will be described in detail below with reference to the accompanying drawings. The preferred embodiments apply the present invention to an optical element forming mold for forming an optical lens, a diffractive optical element and the like.

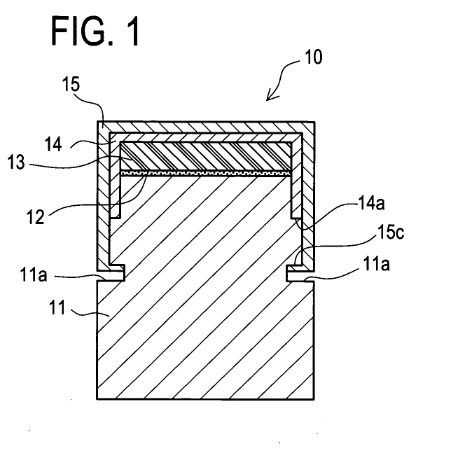

As shown in FIG. 1, an optical element forming mold 10 directed to the present embodiment consists of a matrix 11, a bond layer 12, a heat insulating layer 13, an intermediate layer 14, and a surface processed layer 15 laminated in this order from its bottom. In FIG. 1, an upper face of the matrix 11 corresponds to a base level to forming layers thereon and its top end is offset in negative. The matrix 11 has a groove 11a for gripping at the time of maintenance and inspection. The upper face of the matrix 11 is formed in a rough form of a molded item. The bond layer 12 is coated for enhancing adhesion of the matrix 11 and the heat insulating layer 13. As to the matrix 11 and the bond layer 12, what have conventionally been used are used in the present embodiment.

The heat insulating layer 13 is made of ceramic material excellent in heat insulation. Ceramic material is used so as to prevent the situation that heat of resin material is taken to the matrix 11 and resin is cooled down rapidly when forming an optical element or the like by injection molding. The heat insulating layer 13 is formed in a desired form by machine work, whereby the heat insulating layer 13 does not have thickness variation caused by forming. Since thus formed heat insulating layer 13 does not have roll over to its periphery and the periphery is an edge, form-transfer accuracy of the periphery is improved. Furthermore, the intermediate layer 14, above the heat insulating layer 13, can be made thin.

The intermediate layer 14 is provided so as to enhance adhesion of the heat insulating layer 13 and the surface processed layer 15. While the heat insulating layer 13 is made of ceramic material, the surface processed layer 15 is made of metallic material. Therefore, the intermediate layer 14 is preferably made of material which has affinity with the both materials. So, as material suitable for the intermediate layer 14, metallic material, cermet consisting of metal and ceramic, or gradient material, for example, is used. By using such material, adhesion of the heat insulating layer 13 and the intermediate layer 14 and that of the intermediate layer 14 and the surface processed layer 15 are made strong. That is, the intermediate layer 14 helps to enhance adhesion of the heat insulating layer 13 and the surface processed layer 15. As to cermet, the material of the heat insulating layer 13 is suitable for base material of it. As to gradient material, ingredient ratio is preferably changed from the side closer to the heat insulating layer 13 to the side closer to the surface processed layer 15 with reference to lamination thickness direction. That is, in the intermediate layer 14 made of gradient material, base material of the heat insulating layer 13 is rich at the side closer to the heat insulating layer 13 and base material of the surface processed layer 15 is rich at the side closer to the surface processed layer 15.

The intermediate layer 14 covers not only an upper face of the heat insulating layer 13 but also front, rear, left, and right faces thereof in FIG. 1. Therefore, after the intermediate layer 14 is formed, the heat insulating layer 13 is not exposed to the external. Furthermore, a marginal portion 14a of the intermediate layer 14 gets in contact with the matrix 11 directly. That is, forming the intermediate layer 14, the offset portion of the matrix 11 is filled. Since a desired form has been formed with the heat insulating layer 13, the intermediate layer 14 may be formed as thinly as the desired form can be kept. Thereby, external processing of the intermediate layer 14 can be omitted. Therefore, the intermediate layer 14 can be formed with thickness not exceeding 200 μm. The intermediate layer 14 is so thin that adhesion of the heat insulating layer 13 and the surface processed layer 15 can be enhanced. Furthermore, since external processing of the intermediate layer 14 is not required, the surface processed layer 15 can be laminated on the intermediate layer 14 as it is after being formed.

Cutting work is applied to the upper face of the surface processed layer 15 in FIG. 1, whereby a mold face is formed thereon. The surface processed layer 15 is preferably made of metallic material. Especially, non-ferrous metal such as nickel or the like is preferable, however, nitrided metal, carbided metal, or carbo-nitride metal is acceptable. The surface processed layer 15 covers the entirety of the intermediate layer 14. Furthermore, a marginal portion 15c of the surface processed layer 15 gets in contact with the matrix 11 directly, and a part of the marginal portion 15c gets into the groove 11a. Both the matrix 11 and the surface processed layer 15 are made of metallic material. Therefore, they are adhered to each other preferably and never get separate from each other even though thermal hysteresis is added.

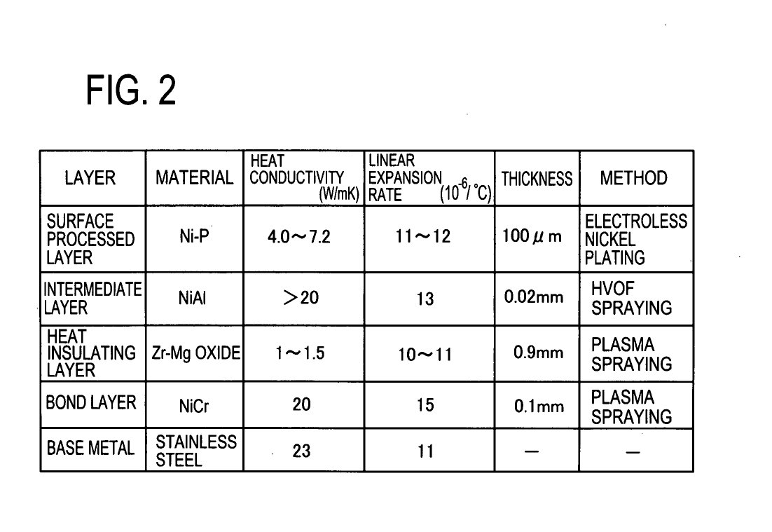

Next, there will be described on example of material and manufacturing method of respective layers by referring to FIG. 2. Although FIG. 2 lists out in accordance with the order of layer lamination shown in FIG. 1, however, here will be described from the last order of FIG. 2 in accordance with manufacturing procedure. Firstly, the matrix 11 is formed with stainless steel or the like generally used for a mold. For the matrix, a material which satisfies heat conductivity of 23 W/mk and linear expansion rate of 11×10⁻⁶/k is selected here. As the bond layer 12, NiCr alloy is selected and a layer of about 0.1 mm thickness is formed by plasma spraying on the base material 11. As for the bond layer 12 formed here, heat conductivity was 20 W/mk and linear expansion rate was 15×10⁻⁶/k.

For the heat insulating layer 13, material of which heat conductivity is low and linear expansion rate is closer to that of the matrix 11 is suitable. Additionally, material which has less pin holes after being sprayed is more preferable. As main material of the heat insulating layer 13, zirconium oxide, aluminum oxide, titanium oxide, chrome oxide or the like can be used. Here, ZrO₂·24MgO is selected. This material is excellent in low porosity rate of a sprayed layer and high denseness. Linear expansion rate of it is close to that of the matrix 11. Furthermore, the material exhibits high resistibility against thermal shock. For the heat insulating layer 13, there is selected a one which satisfies heat conductivity of 1˜1.5 W/mk and linear expansion rate of 10˜11×10⁻⁶/k. Since melt temperature of the material is high, the heat insulating layer 13 was formed by plasma spraying which can create a high-temperature plasma state. The thickness of the heat insulating layer 13 formed here was about 0.9 mm. Furthermore, machine work is applied to the after-sprayed heat insulating layer 13 to form a form of a desired molded item.

As the material of the intermediate layer 14, NiAl alloy is selected here. Of this material, heat conductivity is higher than 20 W/mk and linear expansion rate is about 13×10⁻⁶/k. The intermediate layer 14 was formed here in about 0.02 mm thickness by spraying the material with a method of high velocity flame spraying (HVOF spraying). Although plasma spraying is applicable here, HVOF spraying is more preferable. This is because the surface processed layer 15 is likely to get pin holes in the case the surface of the after-sprayed intermediate layer 14 is rough, which can be a cause of defects. According to HVOF spraying, a part of kinetic energy is converted into thermal energy when metallic particles of material for the intermediate layer 14 collide against the heat insulating layer 13. A fine lamination film is formed by melting and dynamic force of collision. Therefore, the surface processed layer 15 is hard to get pin holes.

As the surface processed layer 15, electroless Ni—P plating layer is selected here. Since the intermediate layer 14 thus covers the heat insulating layer 13 thoroughly, the electroless plating is applied to the intermediate layer 14 and the matrix 11 but not applied to anywhere of the heat insulating layer 13. The former two layers are made of electrically conductive material while the heat insulating layer 13 is made of ceramic material. Therefore, under same pre-plating process condition, plating to those layers is possible and plating quality is therefore improved. Additionally, adhesion of plating is preferable. For the surface processed layer 15, a material which satisfies heat conductivity of 4.0˜7.2 W/mk and linear expansion rate of 11˜12×10⁻⁶ /k was selected here.

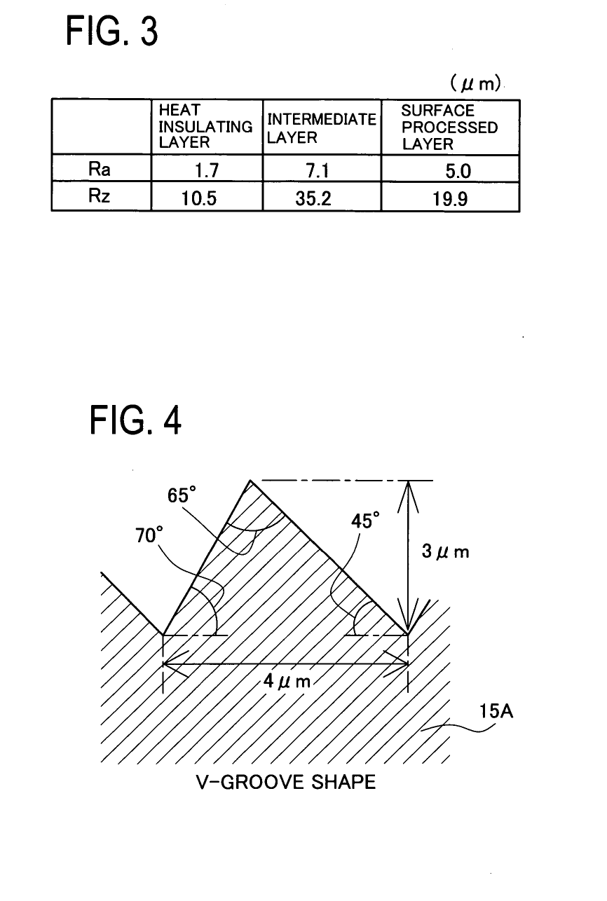

In the present embodiment, surface roughness after respective layers are formed is shown in FIG. 3. It is to be noted that FIG. 3 shows surface roughness of the heat insulating layer 13 obtained after grinding work is applied. As shown in FIG. 3, roughness average (Ra) with reference to center line of the surface processed layer 15 is 5 μm, which is a preferable result.

Surface processing depending on to-be-manufactured optical element is applied to the thus formed surface processed layer 15, whereby the optical element forming mold is completed. For example, as shown in FIG. 4, a surface processed layer 15A with a V-shaped groove form can be formed by cutting work with a diamond tool. A portion indicated with hatching in FIG. 4 corresponds to the surface processed layer 15A which has V-shaped grooves arranged in parallel with 4 μm intervals. Depth of the grooves is 3 μm, and groove basic angle is 65 degrees. A desired form can be formed by etching, as well.

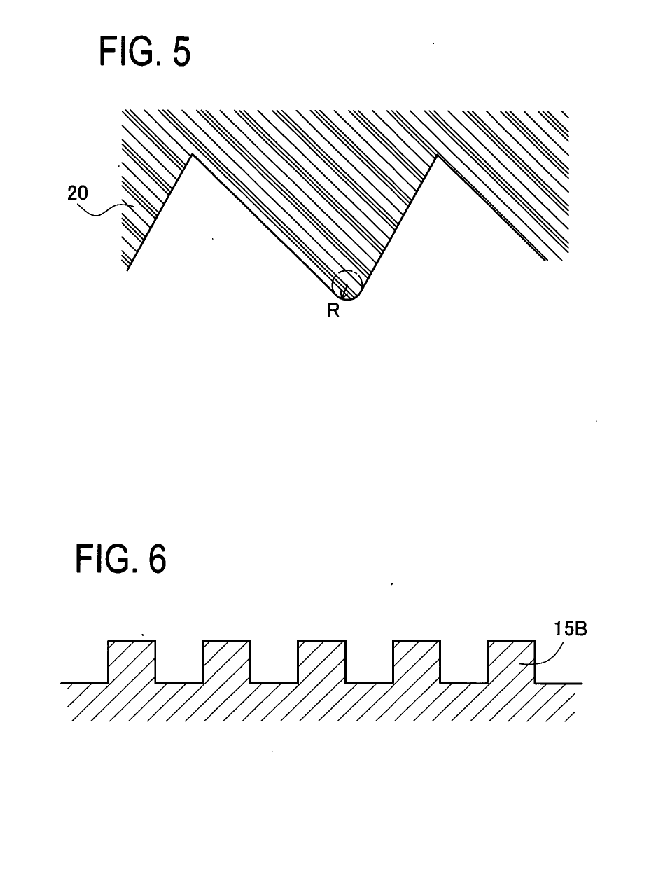

Next, an optical element manufactured with thus formed optical element forming mold 10 directed to the present embodiment was inspected on its form-transfer accuracy. As the inspection target, there was used a mold which has a surface processed layer 15A with V-shaped groove form as shown in FIG. 4. Amorphous polyolefin was used as molding material, and molding conditions were set as follows: mold temperature 115° C.; resin temperature 250° C.; cooling time 60 sec.; dwelling force 100 MPa; and injection speed 200 mm/sec. FIG. 5 shows a cross sectional view of a molded item. Measured in accordance with SEM (scanning electron microscope) observation, a radius R, at a tip form of the molded item was about 0.15 μm. This figure indicated sufficiently preferable form-transfer accuracy. FIG. 5 shows its mold face downward corresponding to FIG. 4. Furthermore, as to a surface processed layer 15B of a binary form as shown in FIG. 6, preferable form-transfer accuracy could be verified, as well.

According to the experiment by the inventor, the following facts were figured out. Firstly, it was found out that form-transfer accuracy gets better as thickness of the intermediate layer 14 is made thinner. As described, thickness of the intermediate layer 14 could be made thin by forming the heat insulating layer 13 into a desired form in advance. So, it is preferable that the intermediate layer 14 is formed thin within the range where the heat insulating layer 13 is not exposed partially due to unevenness of spraying. For example, a range between 10 μm and 30 μm is suitable. In the case thickness of the intermediate layer 14 is 200 μm or thicker, separation and deformation due to membrane stress occur in the layer in use, which is not preferable.

Next, other embodiments will be described. Firstly, as material for the intermediate layer 14, cermet can substitute for NiAl alloy. In this case, the intermediate layer 14 can be formed by spraying cermet. Especially, use of cermet is effective when manufacturing a large-sized member which is significantly influenced by coefficient difference of linear expansion. As a cermet to be used, it is preferable which is based on material of the insulating layer 13. For example, zirconia nickel system such as ZrO₂·8MgO·35NiCr, ZrO₂·8Y₂O₃·25NiCr, aluminum nickel system such as Al₂O₃·3O(Ni₂₀Al), or the like can be used.

Alternatively, as the substitute for NiAl alloy, gradient material can be used for the intermediate layer 14. It is preferable that compounding ratio of the intermediate layer 14 is changed from base material of the heat insulating layer 13 to that of the surface processed layer 15 with reference to lamination direction. As the method for forming such compounding cermet, for example, prepare several kinds of blended powder different in blend proportion in advance, and supply different proportions of blended powder step by step to build up a layer consisting of different compounding ratio in lamination thickness direction. Alternatively, make a two-channeled powder feeder feed different materials and change feeding ratio of the two different materials gradually. For example, there can be formed the intermediate layer 14 by gradually changing compounding ratio from Zr·Mg-oxide-rich one to NiAl-alloy-rich one.

Furthermore, the surface processed layer 15 may be formed by spraying metallic material on the intermediate layer 14 directly instead of electroless nickel plating. For example, NiAl alloy may be formed by HVOF spraying. Following this manner, the heat insulating layer 13 to the surface processed layer 15 can be formed spraying process only, without plating process. Accordingly, the heat insulating layer 13, the intermediate layer 14, and the surface processed layer 15 can be formed successively with one spraying machine. With this manner, it is preferable to select metallic material which is fine and does not cause pin holes during spraying. In the case the surface processed layer 15 is formed by spraying, it is not necessary to cover side faces of the heat insulating layer 13 with the intermediate layer 14. Furthermore, even the one without an intermediate layer 14 can possibly be used.

Alternatively, the surface processed layer 15 may be formed by sputtering. In the case formed by sputtering, the surface processed layer 15 does not get pin holes. As material for sputtering, the followings are usable: as nitride, TiN, CrN, AlN, or the like; as carbide, TiC, SiC, or the like, or DLC (diamond-like carbon); or carbo-nitride or the like. In this case, also, it is not necessary to cover side faces of the heat insulating layer 13 with the intermediate layer 14. Furthermore, even the one without an intermediate layer 14 can possibly be used.

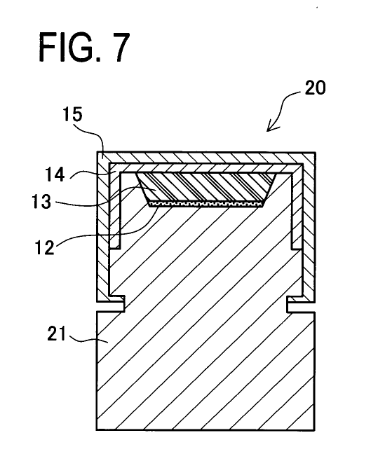

In the case of a mold for a product to which form-transfer accuracy is not required in its most outer periphery, an optical element forming mold 20 with a ship-bottom-shaped matrix 21, as shown in FIG. 7, may be used. With such a shaped matrix 21, adhesion of the matrix 21 and a heat insulating layer 13 is improved. Furthermore, in the case a contact area of the matrix 21 and an intermediate layer 14 is sufficiently secured around the periphery portion of the matrix 21, it is not necessary to cover side faces of the matrix 21 with the intermediate layer 14.

As described, the optical element forming mold 10 directed to the present embodiment has the matrix 11 which has a mold base level, the heat insulating layer 13 provided over the mold base level of the matrix 11, the intermediate layer 14 provided on the heat insulating layer 13, and the surface processed layer 15 which covers the intermediate layer 14. Furthermore, the heat insulating layer 13 is a ceramic layer, the surface processed layer 15 is a metallic material layer, and the intermediate layer 14 is made of metal, cermet, or gradient material, whereby adhesion of the heat insulating layer 13 and the surface processed layer 15 is enhanced. Marginal portions of the intermediate layer 14 and the surface processed layer 15 get in contact with the matrix 11 directly, whereby adhesion of those layers and the matrix 11 is excellent. Thickness of the intermediate layer 14 is 200 μm or thinner, whereby preferable form-transfer accuracy is secured. In conclusion, there is realized the optical element forming mold 10 equipped with the surface processed layer 15 excellent in adhesion and capable of obtaining high form-transfer accuracy.

The embodiments are described above merely as illustrative examples, but it is nothing to limit the invention in any way. Therefore, the invention can obviously be improved or modified in various ways without deviating from its essentials. For instance, materials and thickness of the respective layers described herein are merely examples, but it is nothing to limit. Furthermore, for instance, the present invention is not limited to molds for optical elements but it is applicable to molds of fine sized members manufactured by injection molding of resin.

Relating to the present invention, it is preferable that the heat insulating layer is a ceramic layer, the surface layer is a metal layer, especially a non-ferrous metal layer which is suitable for plating and exhibits high corrosion resistance, the intermediate layer is made of metal or cermet or gradient material and thickness of the layer does not exceed 200 μm, and a bond layer is provided between the matrix and the heat insulating layer so as to enhance adhesion of those. Furthermore, the surface layer can be manufactured through processing such as electroless plating, metal spraying, sputtering and the like.

Relating to the present invention, it is preferable that the intermediate layer is covering the heat insulating layer and its marginal portion is in contact with the matrix. It is also preferable that the surface layer is covering the intermediate layer and its marginal portion is in contact with the matrix. Furthermore, it is preferable that a step of processing the heat insulating layer after spraying to form a form of a target molded item is carried out prior to forming an intermediate layer.

According to the present invention, there is provided an optical element forming mold equipped with a surface processed layer with excellent adhesion and capable of realizing high form-transfer accuracy.

What is claimed is:

1. An optical element forming mold comprising:
a matrix;
a heat insulating layer provided over the matrix formed by spraying;
an intermediate layer provided on the heat insulating layer; and
a surface layer which covers the intermediate layer and includes a mold face for molding an optical element.

2. An optical element forming mold according to claim 1,
wherein the heat insulating layer is made of ceramic.

3. An optical element forming mold according to claim 1,
wherein the surface layer is made of metal.

4. An optical element forming mold according to claim 3,
wherein the surface layer is made of non-ferrous metal.

5. An optical element forming mold according to claim 1,
wherein the intermediate layer is made of metal.

6. An optical element forming mold according to claim 1,
wherein the intermediate layer is made of cermet.

7. An optical element forming mold according to claim 1,
wherein compounding ingredient of the intermediate layer is changing such that a component common to the heat insulating layer is richer as closer to the heat insulating layer and a component common to the surface layer is richer as closer to the surface layer with reference to lamination thickness direction.

8. An optical element forming mold according to claim 1,
wherein thickness of the intermediate layer does not exceed 200 μm.

9. An optical element forming mold according to claim 1,
wherein the intermediate layer is covering the heat insulating layer and a marginal portion of the intermediate layer is in contact with the matrix.

10. An optical element forming mold according to claim 1,
wherein the surface layer is covering the intermediate layer and a marginal portion of the surface layer is in contact with the matrix.

11. An optical element forming mold according to claim 1
further comprises a bond layer provided between the matrix and the heat insulating layer so as to enhance adhesion of the matrix and the heat insulating layer.

12. A manufacturing method of an optical element forming mold comprising the steps of:
forming a heat insulating layer over a matrix by spraying;
forming an intermediate layer on the heat insulating layer;
forming a surface layer on the intermediate layer; and
forming a mold face for molding an optical element on a surface of the surface layer.

13. A manufacturing method of an optical element forming mold according to claim 12
further comprising a step of processing the heat insulating layer after spraying to form a form of a target molded item thereon, prior to forming an intermediate layer.

14. A manufacturing method of an optical element forming mold according to claim 12,
wherein the heat insulating layer is formed of ceramic.

15. A manufacturing method of an optical element forming mold according to claim 14,
wherein the intermediate layer is formed of metal or cermet covering the heat insulating layer thoroughly.

16. A manufacturing method of an optical element forming mold according to claim 15,
wherein the intermediate layer is formed by spraying.

17. A manufacturing method of an optical element forming mold according to claim 15,
wherein the surface layer is formed of metal.

18. A manufacturing method of an optical element forming mold according to claim 17,
wherein the surface layer is formed by plating.

19. A manufacturing method of an optical element forming mold according to claim 12,
wherein the surface layer is formed by spraying.
